(19) United States
(12) Patent Application Publication
(10) Pub. No.: US 2005/0025611 A1
(43) Pub. Date: Feb. 3, 2005

(54) Anti-theft nut and bolt assembly

(76) Inventor: Andre Rioux, Longueuil (CA)

Correspondence Address: MANELLI DENISON & SELTER, 2000 M STREET NW SUITE 700, WASHINGTON, DC, 20036-3307, US

(21) Appl. No.: 10/896,063

(22) Filed: Jul. 22, 2004

(30) Foreign Application Priority Data
Jul. 30, 2003 (CA) 2,436,350

(51) Int. Cl. F16B 39/284

(52) U.S. Cl. 411/429

(57) ABSTRACT

A locked nut and bolt assembly for bolting a plurality of members one to another in tight abutment, the assembly having: a bolt having a head and a threaded body portion; a complementarily-threaded nut having a nut outside diameter received in locked engagement on the bolt; the plurality of members retained on the bolt between the head and the nut; a casing having—a first terminal portion defining an inwardly protruding retained portion defining a first aperture embracing the bolt body portion and the retained portion in abutment with and retained by the tightened nut; a second terminal portion defining an inwardly protruding covering portion defining a second aperture embracing the bolt body portion and the covering portion in covering close proximity to the nut as to prevent access to the nut by nut engaging and turning means to effect loosening thereof; and a body between the first and the second terminal portions and surrounding the nut in close proximity thereto as to define therebetween a receiving recess for the nut engaging and turning means. The assembly constitutes an anti-theft nut and bolt locking device having enhanced difficulty for unwanted removal of the nut and bolt.

### FIELD OF THE INVENTION

This invention relates to a tightened nut and bolt assembly used to retain a plurality of members together in such a manner as to reduce the likelihood of unwanted removal by theft or accident and reuse of the nut and bolt from the assembly. It also relates to a kit of parts combination for use in said assembly; and to a method of forming said assembly.

### BACKGROUND TO THE INVENTION

Threaded nuts and bolts of various sizes have been extensively used in a vast ubiquitous array of industries, utilities and situations for retaining a plurality of members, articles and the like, together.

There are instances where the unwanted dismantling of a tightened nut and bolt assembly, i.e. by accident or the identical stealing of the nut and bolt can result in damage to the retained members, danger to personnel, and expense and inconvenience to the owner or operator of the property in replacing the nut and bolt.

One such example of the dangerous, unwanted stealing of tightened nuts and bolts occurs by their removal from free-standing tower structures, such as electricity pylons and communication towers, which cross both heavily inhabited and lightly inhabited geographic regions of a country.

One method of reducing the likelihood of unwanted loosening of a nut and bolt assembly is to weld the nut to either the bolt and/or the plurality of members. However, in very many situations transporting the welding equipment to the site of the tower, for example, in the bush, jungle or mountainous regions; or welding the structural spars struts, girders and the like above ground is difficult and labour intensive, in requiring an extra, generally unionized, person, namely, a welder.

Further, the welding process destroys the localized galvanized surface. Yet further, the weld spots can generally be easily ground off.

There is, therefore, a need for providing a tightened nut and bolt assembly which reduces the ability for the nut and bolt to be untightened and, thus, the incentive for a thief to attempt such action, or by accident.

### SUMMARY OF THE INVENTION

It is an object of the present invention to provide an anti-theft nut and bolt assembly having enhanced difficulty for unwanted removal of the nut and bolt therefrom.

It is a further object to provide a kit of parts comprising in combination a nut and bolt and associated member for use in the aforesaid anti-theft nut and bolt assembly.

It is a further object to provide a method of providing said anti-theft nut and bolt assembly from said kit of parts.

Accordingly, in one aspect the invention provides a locked nut and bolt assembly for bolting a plurality of members one to another in tight abutment, said assembly comprising:
a bolt having a head and a threaded body portion;
a complementarily-threaded nut having a nut outside diameter received in locked engagement on said bolt;
said plurality of members retained on said bolt between said head and said nut;
a casing having—
a first terminal portion defining an inwardly protruding retained portion defining a first aperture embracing said bolt body portion and said retained portion in abutment with and retained by said tightened nut;
a second terminal portion defining an inwardly protruding covering portion defining a second aperture embracing said bolt body portion and said covering portion in covering close proximity to said nut as to prevent access to said nut by nut engaging and turning means to effect loosening thereof; and
a body between said first and said second terminal portions and surrounding said nut in close proximity thereto as to define therebetween a receiving recess for said nut engaging and turning means.

Nut engaging and turning means, includes, for example, a socket head as part of a socket and wrench set.

Preferably, the casing is of a cylindrical form and wherein the first aperture and/or second aperture, has a diameter less than the outside diameter of the nut.

Thus, preferably, the retained portion and the covering portion protrude essentially radially of the casing.

Most preferably, the assembly as hereinabove defined further comprises a self-locking circular washer between and in abutment with the plurality of members and the nut. Preferably, the washer has a smaller outside diameter than the outside diameter of the nut so as to define with the nut a washer peripheral circumferencial recess and said retained portion constitutes a lip portion which is in abutment with the washer under the nut within the recess.

The casing is most preferably formed of a metallic material, for example, stainless steel.

In a further aspect, the invention provides a kit of parts comprising in combination:
a threaded bolt having an outer diameter;
a complementarily threaded nut, having an outer diameter and receivable by said bolt;
and a cylindrical casing receivable on said bolt and having
a first terminal portion inwardly deformable under turnable screw pressure to produce an essentially radial end portion defining a circular aperture of smaller diameter than said nut outer diameter but of a greater diameter than said bolt;
a second terminal portion having an inner diameter less than said nut outer diameter; and
a cylindrical body between said first and second portions and having a body inner diameter greater than said second terminal portion inner diameter and said nut outer diameter;
and wherein said body and said nut define a nut engaging and turning means recess therebetween when said casing and said nut are located on said bolt.

By the term “turnable screw pressure” is meant the application of a reasonable effective force by a racket, spanner or like tool, manual or motor driven, to which a suitably shaped deforming tool received on the bolt tool acts on the second terminal portion of the casing to effect the inwardly bending thereof.

In a yet further aspect, the invention provides a method of producing a locked nut and bolt assembly as hereinabove defined using nut, bolt and casing components as defined in the kit of parts as hereinabove defined, said method comprising
(i) locating said nut, said plurality of members and said casing on said bolt; wherein
   (a) said retained portion of said first terminal portion is between said plurality of members and said nut; and
   (b) said casing and said nut define a nut engaging and turning means recess therebetween;
(ii) inserting an effective nut engaging and turning means within said recess;
(iii) tightening said nut with said engaging and turning means to lock said nut, said casing first terminal portion and said plurality of members on said bolt;
(iv) withdrawing said nut engaging and turning means from said recess, and
(v) deforming said inwardly deformable second terminal portion to produce said covering having said circular aperture of smaller diameter than said nut outer diameter in said close proximity to said nut as to prevent access to said nut by nut engaging and turning means to effect loosening thereof.

### BRIEF DESCRIPTION OF THE DRAWINGS

In order that the invention may be better understood, a preferred embodiment will now be described, by way of example only, with reference to the accompanying drawings wherein

FIG. 1 is a diagrammatic vertical cross-section of a tightened anti-theft nut and bolt assembly according to the invention;

FIG. 2 is a diagrammatic vertical cross-section of a kit of parts combination according to the invention in a tightened mode retaining two members together prior to forming the anti-theft tightened assembly shown in FIG. 1;

FIG. 3 shows the embodiment of FIG. 2 having a socket in engagement with the nut;

FIG. 4 shows the tightened anti-theft nut and bolt assembly of FIG. 1 having a casing deformation tool located on the nut after the casing has been deformed; and wherein the same numerals denote like parts.

### DETAILED DESCRIPTION OF A PREFERRED EMBODIMENT

With reference to FIG. 1, this shows generally as 10, well-known heavy duty nut and bolt components, stainless steel threaded hexagonal nut 12 tightened on a stainless steel bolt 14 to retain two steel plates 16, 18 of a tower or pylon support (not shown). Nut 12 has an outer diameter d₁.

Bolt 14 has a smooth body portion 20 and a complementary-threaded portion 22, upon which is tightened nut 12 and a lock washer 24 held on bolt portion 22 between nut 12 and plate 16. Bolt 14 has a partial conical head 26 having a pentagonal recess adapted 27 to receive a heavy-duty pentagonal key (not shown).

Washer 24 has an outer diameter d₂ smaller than nut outer diameter d₁, so as to provide a recess 28 with nut 12 and plate 16.

Surrounding nut 12 is a cylindrical steel casing 30 having a body 32 between an outer terminal portion 34 and an inner terminal portion 36 distant of portion 34 in abutment with plate 16.

Portion 34 defines a cylindrical aperture 37 of diameter d₃ which receives bolt portion 22 and which has been formed by deformation of portion 34 as hereinafter described, to constitute an inwardly protruding, essentially radially of casing 30, cover 39 adjacent the center end 38 of nut 12 in such close proximity to nut 12 and bolt portion 22 so as to prevent subsequent access to nut 12 by any unscrewing means (not shown) to enable nut 12 to be loosened on bolt 14. Thus, diameter d₂ of aperture is less then d₁ of nut 12.

Casing portion 36 defines a cylindrical aperture 40 of diameter d₄ which receives bolt portion 22 and formed an inwardly protruding, essentially radially of casing 30, retained portion 41 within recess 28 in abutment with nut 12, washer 24 and plate 16. Retained portion 41 is, thus, so located under and by nut 12 that casing 30 cannot be lifted or otherwise removed from assembly 10.

It can be readily seen that in order to loosen nut 12 on bolt 14 by unscrewing action directly on nut 12, terminal portion 34 would have to be prised open by leverage means such as by a crowbar, jimmy or the like, or otherwise destroyed to allow access to nut 12. While this is not impossible, casing 30 provides a great disincentive and discouragement for a thief or vandal to spend the time and effort to go to such trouble. Such trouble and disincentive will be enhanced when the assembly is located above ground and plurality of leverages to effect destruction are needed.

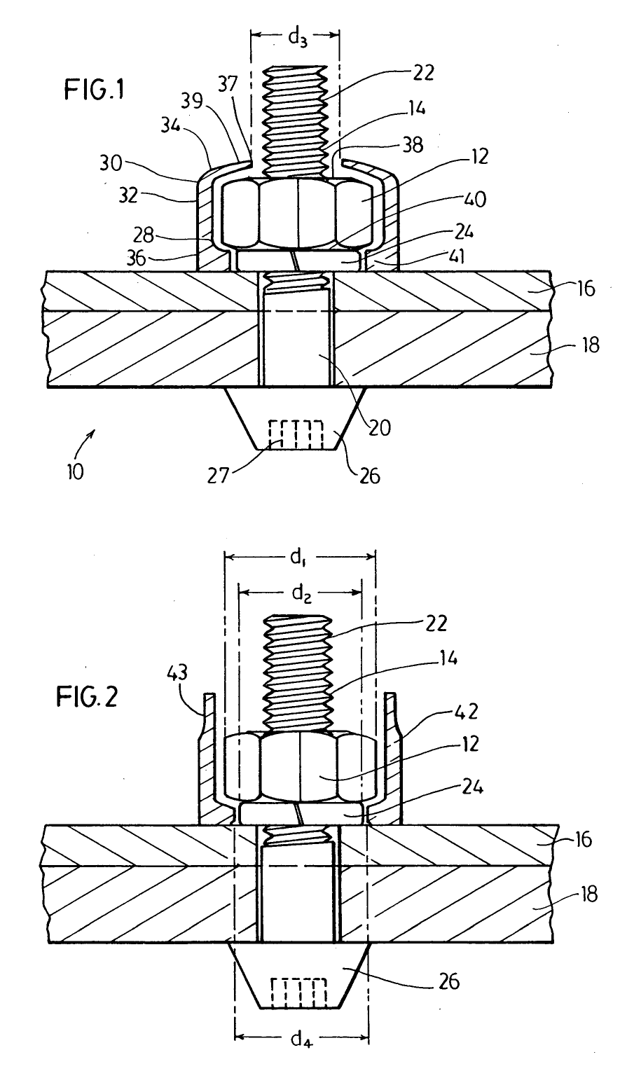

With reference now to FIGS. 2-4, the method for assembling the tightened resultant assembly is now described.

FIG. 2 illustrates a loose assembly of nut 12, bolt 14, plates 16, 18, lockwasher 24 and a pre-deformed casing 42 having a terminal portion 43.

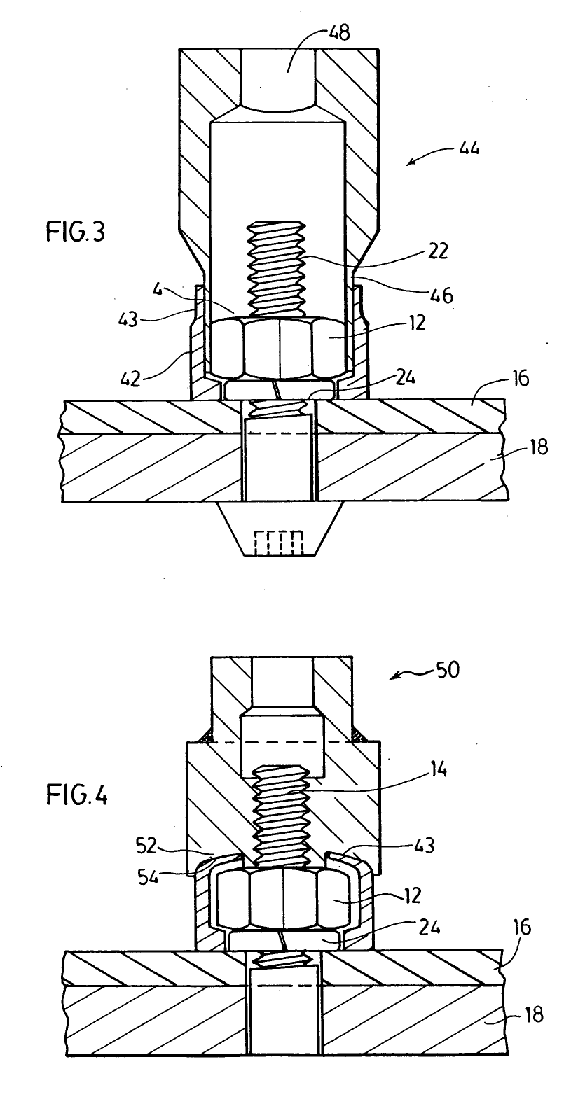

FIG. 3 illustrates the tightening of nut 12 on bolt 14 by a socket shown generally as 44 having a head 46 defining a hexagonal aperture 47 adapted to receive nut 12, which is tightened by action of a ratchet (not shown) located within socket aperture 48. After tightening, socket 44 is removed.

A threaded deformation tool, shown generally as 50, shown in FIG. 4, is then screwed onto bolt 14. Tool 50 has a terminal deformation portion 52 defining a curved annular recess 54 which operably abuts terminal portion 43 which, under pressure from tool 50 induced by ratchet engaged turning of tool 50 on bolt 14, is deformed to produce terminal portion 34 shown in FIG. 1. Tool 50 is subsequently unscrewed and removed.

Although this disclosure has described and illustrated certain preferred embodiments of the invention, it is to be understood that the invention is not restricted to those particular embodiments. Rather, the invention includes all embodiments which are functional or mechanical equivalents of the specific embodiments and features that have been described and illustrated.

1. A locked nut and bolt assembly for bolting a plurality of members one to another in tight abutment, said assembly comprising:
a bolt having a head and a threaded body portion;
a complementarily-threaded nut having a nut outside diameter received in locked engagement on said bolt;
said plurality of members retained on said bolt between said head and said nut;
a casing having—
a first terminal portion defining an inwardly protruding retained portion defining a first aperture embracing said bolt body portion and said retained portion in abutment with and retained by said tightened nut;
a second terminal portion defining an inwardly protruding covering portion defining a second aperture embracing said bolt body portion and said covering portion in covering close proximity to said nut as to prevent access to said nut by nut engaging and turning means to effect loosening thereof; and
a body between said first and said second terminal portions and surrounding said nut in close proximity thereto as to define therebetween a receiving recess for said nut engaging and turning means.

2. An assembly as defined in claim 1 wherein said body of said casing is of a cylindrical form.

3. An assembly as defined in claim 1 wherein said first aperture is of a circular form having a first aperture diameter of smaller size than said nut outside diameter.

4. An assembly as defined in claim 2 wherein said first aperture is of a circular form having a first aperture diameter of smaller size than said nut outside diameter.

5. An assembly as defined in claim 1 wherein said second aperture is of a circular form having a second aperture diameter of smaller size than said nut outside diameter.

6. An assembly as defined in claim 2 wherein said second aperture is of a circular form having a second aperture diameter of smaller size than said nut outside diameter.

7. An assembly as defined in claim 3 wherein said second aperture is of a circular form having a second aperture diameter of smaller size than said nut outside diameter.

8. An assembly as defined in claim 1 wherein said retained portion protrudes essentially radially of said casing; and said covering portion protrudes essentially radially of said casing.

9. An assembly as defined in claim 2 wherein said retained portion protrudes essentially radially of said casing; and said covering portion protrudes essentially radially of said casing.

10. An assembly as defined in claim 3 wherein said retained portion protrudes essentially radially of said casing; and said covering portion protrudes essentially radially of said casing.

11. An assembly as defined in claim 4 wherein said retained portion protrudes essentially radially of said casing; and said covering portion protrudes essentially radially of said casing.

12. An assembly as defined in claim 1 further comprising a self-locking circular washer between and in abutment with said plurality of members and said nut.

13. An assembly as defined in claim 2 further comprising a self-locking circular washer between and in abutment with said plurality of members and said nut.

14. An assembly as defined in claim 3 further comprising a self-locking circular washer between and in abutment with said plurality of members and said nut.

15. An assembly as defined in claim 4 further comprising a self-locking circular washer between and in abutment with said plurality of members and said nut.

16. An assembly as defined in claim 12 wherein said washer has a smaller outside diameter than said nut so as to define a washer peripheral circumferential recess with said nut; and said retained portion constitutes a lip portion in abutment with said washer under said nut within said recess.

17. An assembly as defined in claim 1 wherein said casing is formed of a metallic material.

18. A kit of parts comprising in combination:
a threaded bolt having an outer diameter;
a complementarily-threaded nut, having an outer diameter and receivable by said bolt;
and a cylindrical casing receivable on said bolt and having a first terminal portion inwardly deformable under turnable screw pressure to produce an essentially radial end portion defining a circular aperture of smaller diameter than said nut outer diameter but of a greater diameter than said bolt;
a second terminal portion having an inner diameter less than said nut outer diameter; and
a cylindrical body between said first and second portions and having a body inner diameter greater than said second terminal portion inner diameter and said nut outer diameter;
and wherein said body and said nut define a nut engaging and turning means recess therebetween when said casing and said nut are located on said bolt.

19. A kit of parts as defined in claim 18 further comprising a lockwasher receivable on said bolt and having a washer outer diameter less than said nut outer diameter.

20. A method of producing a locked nut and bolt assembly as defined in claim 1 using nut, bolt and casing components selected from a kit of parts comprising in combination:
a threaded bolt having an outer diameter;
a complementarily-threaded nut, having an outer diameter and receivable by said bolt;
and a cylindrical casing receivable on said bolt and having a first terminal portion inwardly deformable under turnable screw pressure to produce an essentially radial end portion defining a circular aperture of smaller diameter than said nut outer diameter but of a greater diameter than said bolt;
a second terminal portion having an inner diameter less than said nut outer diameter; and
a cylindrical body between said first and second portions and having a body inner diameter greater than said second terminal portion inner diameter and said nut outer diameter;
and wherein said body and said nut define a nut engaging and turning means recess therebetween when said casing and said nut are located on said bolt, said method comprising
(i) locating said nut, said plurality of members and said casing on said bolt; wherein
(a) said retained portion of said first terminal portion is between said plurality of members and said nut; and
(b) said casing and said nut define a nut engaging and turning means recess therebetween;
(ii) inserting an effective nut engaging and turning means within said recess;
(iii) tightening said nut with said engaging and turning means to lock said nut, said casing first terminal portion and said plurality of members on said bolt;
(iv) withdrawing said nut engaging and turning means from said recess, and
(v) deforming said inwardly deformable second terminal portion to produce said covering having said circular aperture of smaller diameter than said nut outer diameter in said close proximity to said nut as to prevent access to said nut by nut engaging and turning means to effect loosening thereof.
